(19) United States
(12) Patent Application Publication
(10) Pub. No.: US 2016/0281423 A1
(43) Pub. Date: Sep. 29, 2016

(54) SINGLE-CORD CONTROL DEVICE FOR ROLLER BLIND

(71) Applicant: UNI-SOLEIL ENT. CO. LTD., TAINAN CITY (TW)

(72) Inventor: YU-TING KAO, TAINAN CITY (TW)

(21) Appl. No.: 14/666,530

(22) Filed: Mar. 24, 2015

(51) Int. Cl. E06B 9/78; B65H 75/48

(52) U.S. Cl. CPC E06B 9/78; B65H 75/48

(57) ABSTRACT

A single-cord control device for roller blind comprises a front base comprising a space covered by a lid for setting a winding element which has a winding channel, an abutting block, and a space for locating a spiral spring, and a rear base comprising a step hole and several blocks. A second shaft inserted into the step hole comprises two tubular sections and two elastic elements covering the tubular sections and an inner and an outer shaft sheath. A first shaft is inserted into the center of the lid and one tubular section, and a curtain torque rod is assembled into a through-hole of the second shaft. The outer shaft sheath comprises a path for the abutting block moving. Therefore, the roller blind is controlled by the single-cord to roll up and down, which cord is wound around the winding element to prevent child from being wound around neck.

### BACKGROUND OF THE INVENTION

1. Field of the Invention

The present invention relates a single-cord control device for roller blind. More particularly, the single-cord of a cord control device for roller blind is wound around to store, so that the cord would not be too long to expose, achieving a preventative measure of safety.

2. Description of Related Art

According to different usage, the curtain has several types, such as traditional curtain, roller blind, Roman shade, and Venetian blind. Whatever which type of the curtain has different size and length to fit the window frame, achieving the effect of entirely obscuring.

The traditional roller blind comprises a base, a rolling device in the base, a curtain, and a bottom bar connected with the curtain. The curtain is controlled by the rolling device to roll up and down. For example, the structure of the traditional roller blind is disclosed as shown in the Taiwan Patent application with the Issued No. M372158 “IMPROVED BEAD CHAIN CONTROL DEVICE OF ROLLER BLIND”, the Taiwan Patent application with the Issued No. M283591 “ROLLER BLIND CONTROLLER FOR HEAVY LOAD”, the Taiwan Patent application with the Issued No. M317233 “IMPROVED ROLLER BLIND CONTROLLER”.

The traditional roller blind is controlled by the circular bead chain to roll up and down, however, the circular bead chain of the traditional roller blind is exposed at the side of the roller blind, so the length of the circular bead chain must to be adjusted and cut according to the height of the actual window frame. Moreover, the circular bead chain is tangled easily if the circular bead chain is not located by a locator. Furthermore, when the child plays the circular bead chain due to ignorance, the circular bead chain is easily twined around the body or the neck of the child, and it is difficult to break free so the child is in danger, forming a big threat in child safety.

### SUMMARY OF THE INVENTION

Therefore, the object of the present invention is to provide a single-cord control device for roller blind, in which the single-cord is wound around to store, so that the cord would not be too long to expose, achieving a preventative measure of safety.

For the above object, a single-cord control device for roller blind comprises a front base comprising a space inside for setting a winding element which has a space for locating a spiral spring, a winding channel and an abutting block, and a rear base comprising a step hole and several blocks on the wall of the step hole. A lid covers the space of the front base to position the spiral spring. A first shaft is inserted into the center of the lid. A second shaft comprising a first and a second tubular section inserted into a first and a second elastic element respectively and an inner and an outer shaft sheath respectively is assembled with a curtain torque rod and is inserted into the step hole of the rear base, so as to engage the first shaft into the first tubular section. The outer shaft sheath comprises a path corresponding to the abutting block for the abutting block moving. Therefore, the roller blind is controlled by pulling the single-cord to roll up and down, and after used, the cord is wound around the winding element to prevent the child from being wound around the neck by the cord, forming the safe protective measure.

According to an embodiment, the single-cord control device for roller blind further comprises an extension section on the lid and engaged into the extension indentation of the winding element, wherein a first shaft hole for inserting the first shaft is on the end of the extension section, and an engagement part at the extension section for fixing the interior end of the spiral spring.

According to an embodiment, the single-cord control device for roller blind further comprises a flap set inside the space of the winding element for fixing the exterior end of the spiral spring, and an extension indentation for engaging with the extension section of the lid extended from the center of the space of the winding element, wherein a second shaft hole for inserting the first shaft is on the end of the extension indentation.

According to an embodiment, the inner shaft sheath has a bump at the outer periphery. A bulge is on the two adjacent paths, and a channel corresponding to the bump of the inner sheath is at the inside of the bulge. Furthermore, a tooth is at the end of the channel for engaging with the bump.

According to an embodiment, a teeth part is opposite the path for engaging to or separating from the blocks of the rear base.

According to an embodiment, the inner periphery of the outer shaft sheath comprises a retaining edge for retaining the second elastic element.

According to an embodiment, the path comprises a straight section, an inclining section.

According to an embodiment, the front base comprises a cord hole on the wall of the space.

According to the above description and embodiments, the single-cord control device for roller blind of the present invention has the advantages as following:
1. In the single-cord control device for roller blind of the present invention, the roller blind is rolled up and down by pulling a single-cord.
2. In the single-cord control device for roller blind of the present invention, a single-cord is pulled to roll up and down the roller blind, and after used, the single-cord is wound around via the spiral spring in the control device, so the child is prevented from being wound around the neck by the cord, achieving a protective measure of safety.

### BRIEF DESCRIPTION OF THE DRAWINGS

FIG. 1 is a perspective view of a single-cord control device for roller blind according to the embodiment of the present invention;

FIG. 2 is an exploded view of a single-cord control device for roller blind according to the embodiment of the present invention;

FIG. 3 is a sectional view of a single-cord control device for roller blind according to the embodiment of the present invention;

FIG. 4 is a perspective view of a spiral spring which is compressed according to the embodiment of the present invention;

FIG. 5 is a perspective view of the relationship between an outer shaft sheath and an inner shaft sheath according to the embodiment of the present invention when the cord is pulled;

FIG. 6 is a sectional view of a single-cord control device for roller blind according to the embodiment of the present invention when the cord is pulled;

FIG. 7 is a perspective view of the relationship between an outer shaft sheath and an inner shaft sheath according to another embodiment of the present invention when the cord is wound around the winding element; and

FIG. 8 is a sectional view of a single-cord control device for roller blind according to another embodiment of the present invention when the cord is wound around the winding element.

### DETAILED DESCRIPTION OF THE PREFERRED EMBODIMENT

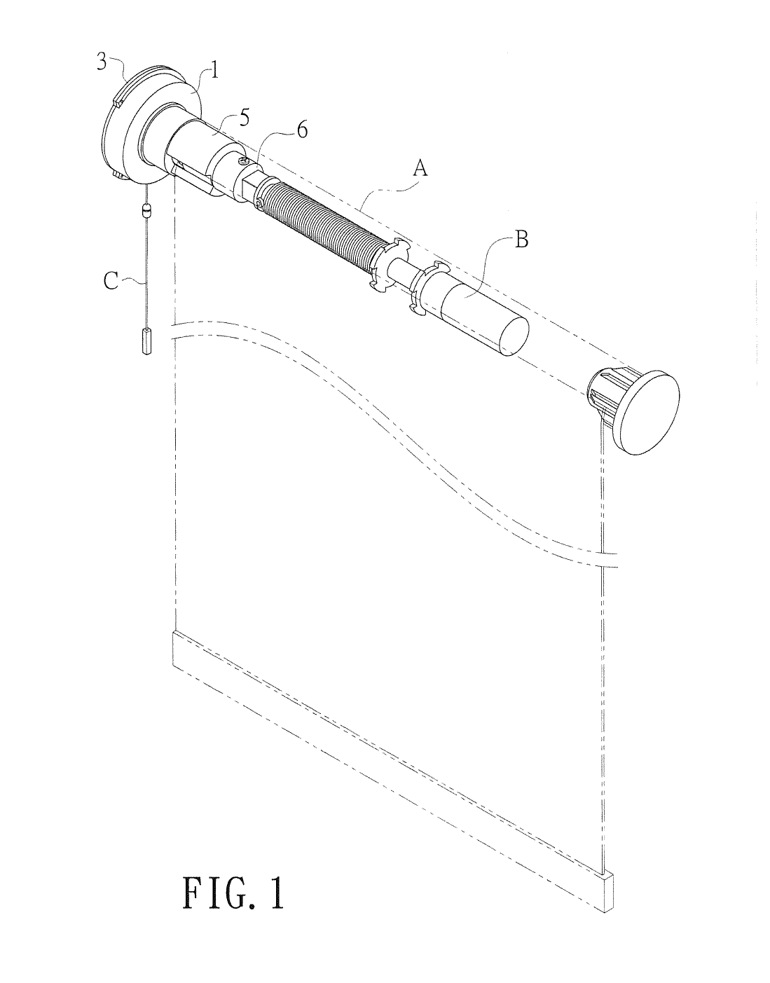

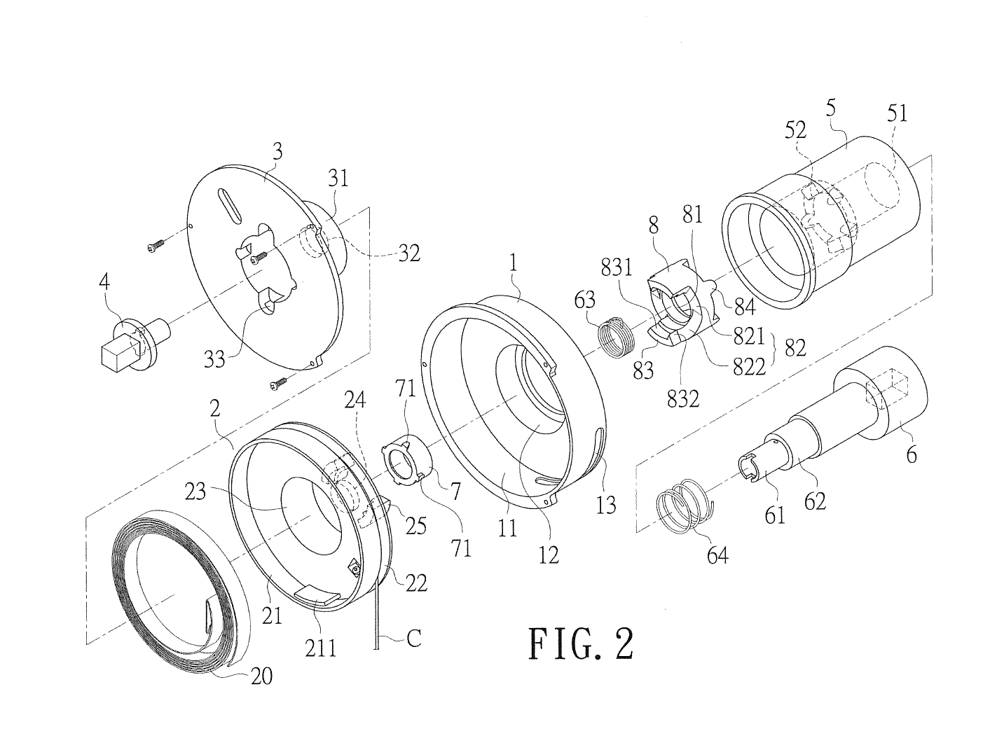

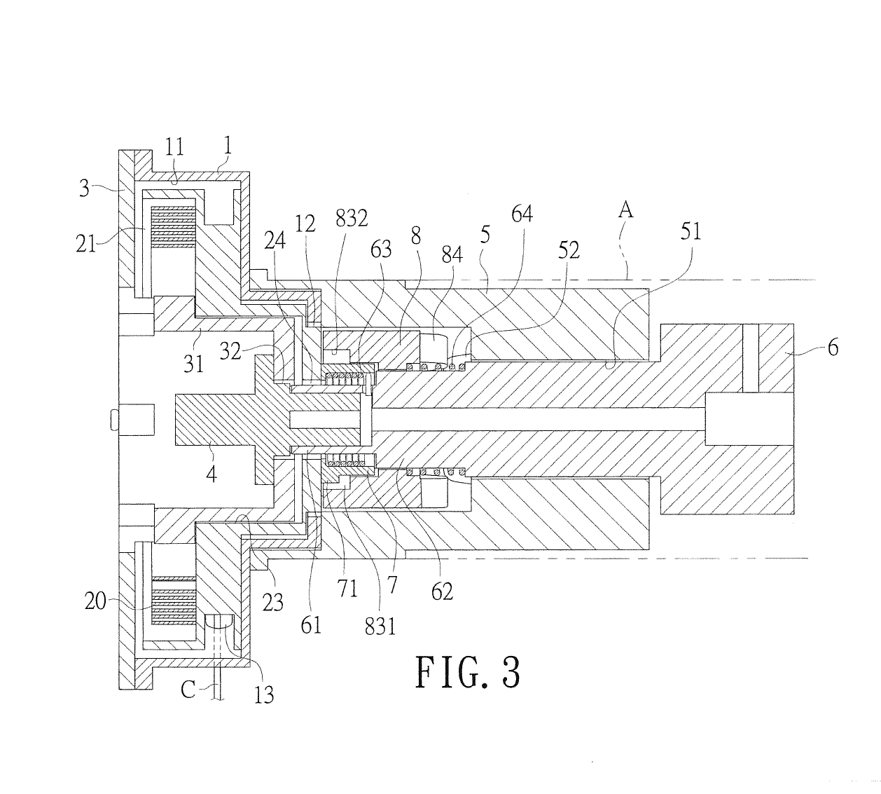

First, please refer to FIG. 1 to FIG. 3, which are a perspective view, an exploded view, and a sectional view of a single-cord control device for roller blind according to the embodiment of the present invention, respectively. The single-cord control device for roller blind comprises a front base 1, a winding element 2, a lid 3, a first shaft 4, a rear base 5, a second shaft 6, an inner shaft sheath 7, and an outer shaft sheath 8.

The front base 1 comprises a space 11 inside, a through hole 12 at the bottom of the space 11, and a cord hole 13 on the wall of the space 11.

The winding element 2 is set in the space 11 of the front base 1 and comprises a space 21 for locating a spiral spring 20, a winding channel 22 at the outside of the winding element 2 for winding a cord C, an extension indentation 23 extended from the center of the space 21 of the winding element 2, a second shaft hole 24 on the end of the extension indentation 23, and at least an abutting block 25 next to the second shaft hole 24 and on the outside of the bottom of the winding element 2. The exterior end of the spiral spring 20 is fixed to a flap 211 set inside the space 21 of the winding element 2. The one end of the cord C is exposed from the cord hole 13 of the front base 1.

The lid 3 covers the space 11 of the front base 1. An extension section 31 is on the lid 3 and engaged into the extension indentation 23 of the winding element 2, and the interior end of the spiral spring 20 is fixed to an engagement part 33 at the extension section 31 of the lid 3. A first shaft hole 32 is on the end of the extension section 31.

The first shaft 4 is inserted into the first shaft hole 32 of the lid 3 and the second shaft hole 24 of the winding element 2.

The rear base 5 is covered with a curtain pole A. The rear base 5 is set back the front base 1 and comprises a step hole 51 and several blocks 52 on the wall of the step hole 51.

The second shaft 6 is opposite to a curtain torque rod B and inserted into the step hole 51 of the rear base 5. The second shaft 6 comprises a first tubular section 61, a second tubular section 62, and a first elastic element 63 and a second elastic element 64 set on the first tubular section 61 and the second tubular section 62 respectively. The internal diameter of the first tubular section 61 is corresponded to the first shaft 4 so as to engage the first shaft 4 to the first tubular section 61.

The inner shaft sheath 7 covers the first elastic element 63 on the first tubular section 61 and is corresponded to the first tubular section 61 of the second shaft 6. A bump 71 is at the outer periphery of the inner shaft sheath 7.

The outer shaft sheath 8 covers the second tubular section 62 of the second shaft 6. The inner periphery of the outer shaft sheath 8 comprises a retaining edge 81 for retaining the second elastic element 64. The outer shaft sheath 8 comprises a path 82 corresponding to the abutting blocks 25 of the winding element 2 for the abutting blocks 25 moving and a teeth part 84 opposite the path 82 for engaging to or separating from the rear base 5. The path 82 comprises a straight section 821, an inclining section 822, and a bulge 83 between the straight section 821 and the inclining section 822. A channel 831 corresponding to the bump 71 of the inner shaft sheath 7 is formed at the inner of the bulge 83, and a tooth 832 radially extended from the channel 831 is adjacent to the inclining section 822.

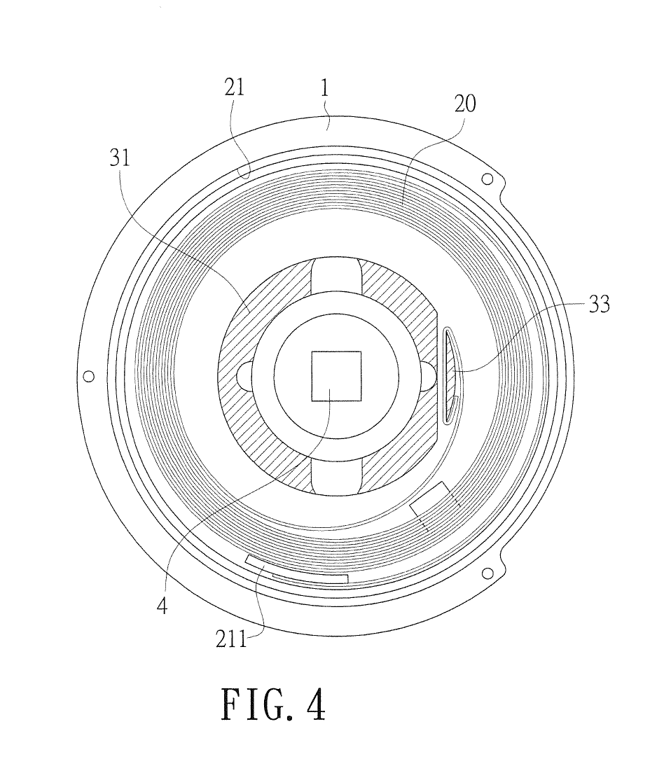

Please refer to FIG. 1 to FIG. 6. When the single-cord control device for roller blind is used, the cord C wound around the winding channel 22 is pulled from the cord hole 13 of the front base 1 to drive the winding element 2 to rotate. Because the interior end of the spiral spring 20 is fixed on the engagement part 33 of the extension section 31, the exterior end of the spiral spring 20 fixed on the flap 211 of the winding element 2 is moved to twist the spiral spring 20 via the rotation of the winding element 2 driven by pulling the cord C, shown as in FIG. 4.

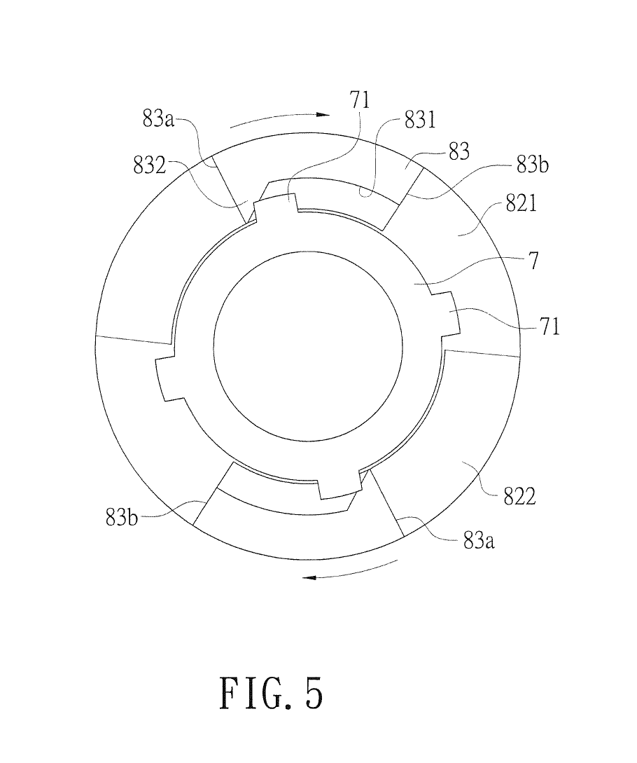

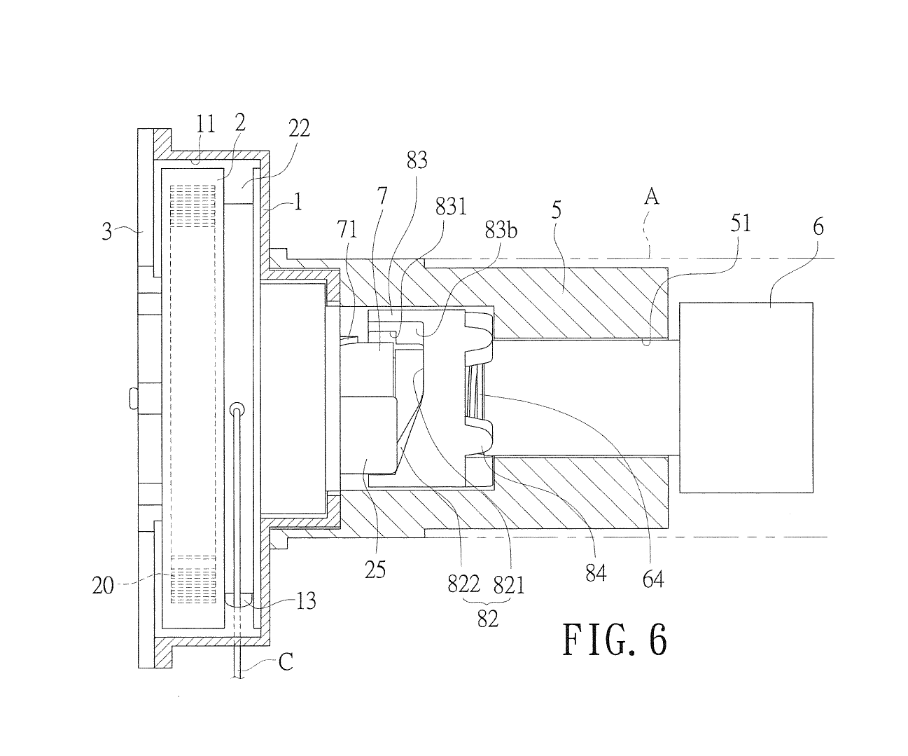

When the cord C is not pulled, the abutting block 25 is at the straight section 821, and the bump 71 which is at the outer periphery of the inner shaft sheath 7 is at the channel 831 of the inner of the bulge 83. Therefore, when the winding element 2 is rotated, the abutting block 25 is rotated to move along the path 82 from the straight section 821 to the inclining section 822. Meanwhile, the outer shaft sheath 8 is rotated in clockwise so the tooth 832 of the bulge 83 is rotated to engage in the side of the bump 71 which is at the outer periphery of the inner shaft sheath 7, shown as in FIG. 5. Because the rotation directions of the inner shaft sheath 7 and the first elastic element 63 are inverse, the first elastic element 63 is withstood the inner wall of the inner shaft sheath 7 and then the inner shaft sheath 7 cannot be rotated. Furthermore, the abutting block 25 is moved to the inclining section 822, so the outer shaft sheath 8 is moved backward to engage the blocks 52 of the rear base 5 in the teeth part 84, as shown in FIG. 6, meanwhile, the second elastic element 64 is compressed by the retaining edge 81. When the cord C is continuous to pull out, the abutting block 25 is continuous to withstand a first side 83a of the bulge 83 to drive the outer shaft sheath 8 to rotate, so as to drive the blocks 52 to move with the teeth part 84, whereby rotating the rear base 5 to drive the curtain pole A to rotate to release the blind down to a desired position.

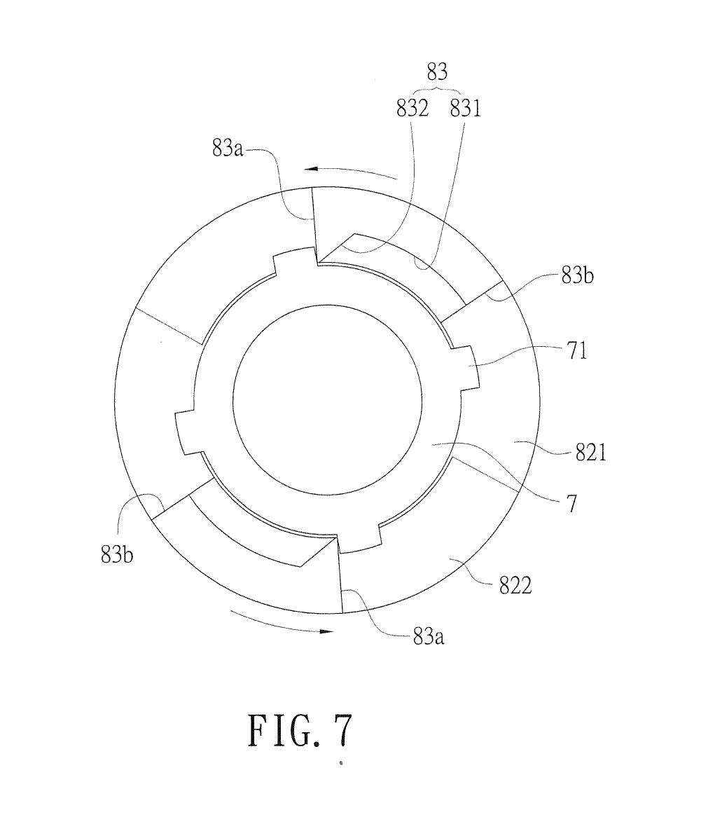

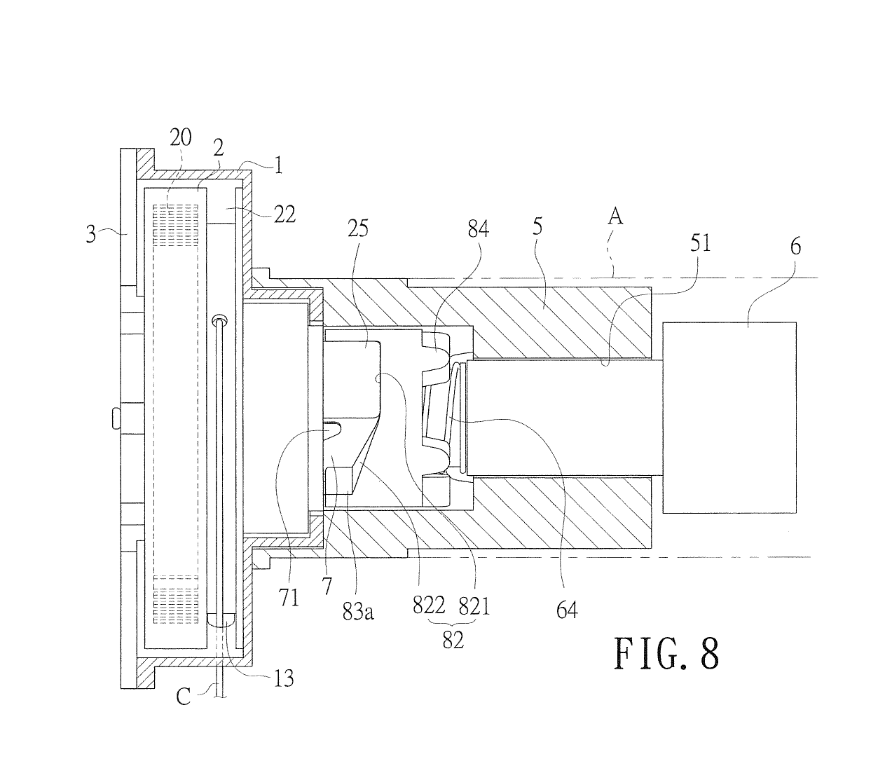

Please refer to FIG. 7 and FIG. 8. When the cord C is released, the spiral spring 20 is returned due to its elasticity to drive the winding element 2 to rotate in reverse, so that the cord C is wound around the winding channel 22 and the abutting block 25 is not withstood the outer shaft sheath 8. Due to the return of the second elastic element 64, the outer shaft sheath 8 is turned back and the abutting block 25 is returned to the straight section 821, meanwhile, the abutting block 25 of the winding element 2 is withstood a second side 83b of the bulge 83 of the outer shaft sheath 8 to rotate the outer shaft sheath 8 in reverse, so that the tooth 832 of the bulge 83 is engaged in the bump 71 which is at the outer periphery of the inner shaft sheath 7. Because the rotation directions of the inner shaft sheath 7 and the first elastic element 63 are the same, the inner shaft sheath 7 and the outer shaft sheath 8 are rotated when the winding element 2 rotates in reverse, meanwhile, the rear base 5 is separated from the teeth part 84 of the outer shaft sheath 8, so that the curtain pole A is not driven to rotate and the blind is kept at the desired position. Finally, the cord C is stored in the winding element 2 and only the end of the cord C is exposed to be convenient to pull, so the child is prevented from being wound around the neck by the cord, achieving a protective measure of safety.

According to the above description and embodiments, the single cord control device for roller blind of the present invention has the advantages as following:
1. In the single-cord control device for roller blind of the present invention, the roller blind is rolled up and down by pulling a single-cord.
2. In the single-cord control device for roller blind of the present invention, a single-cord is controlled to roll up and down the roller blind and is wound around via the spiral spring in the control device after used, so the child is prevented from being wound around the neck by the cord, achieving a protective measure of safety.

What is claimed is:

1. A single-cord control device for roller blind, comprising:
a front base, comprising a space inside, a through-hole at the bottom of the space, and a cord hole on the wall of the space;
a winding element, set in the space of the front base, the winding element comprising:
a space for locating a spiral spring;
a second shaft hole at the bottom of the space of the winding element;
a winding channel at the outside of the winding element for winding a cord, wherein one end of the cord through the cord hole of the front base; and
at least an abutting block, next to the second shaft hole and on the outside of the bottom of the winding element;
is a lid for covering the space of the front base, having a first shaft hole at one surface of the lid;
a first shaft, inserted into the first shaft hole of the lid and the second shaft hole of the winding element;
a rear base, set back the front base, the rear base comprising a step hole and a plurality of blocks on wall of the step hole, wherein the rear base being covered with a curtain pole;
a second shaft, inserted into the step hole of the rear base, the second shaft comprising a first tubular section, a second tubular section, and a first elastic element and a second elastic element set on the first tubular section and the second tubular section respectively, wherein the internal diameter of the first tubular section is corresponded to the first shaft so as to engage the first shaft to the first tubular section;
an inner shaft sheath, covering the first elastic element on the first tubular section, wherein the inner shaft sheath has a bump at the outer periphery;
an outer shaft sheath, covering the second tubular section of the second shaft, the inner periphery of the outer shaft sheath comprising a retaining edge for retaining the second elastic element, wherein the outer shaft sheath comprises a path for the abutting blocks moving and a teeth part opposite the path for engaging to or separating from the rear base, and the path comprises a straight section, a inclining section, a bulge between two sections, and a tooth radially extended from the bulge and adjacent to the inclining section.

2. The single-cord control device for roller blind according to claim 1, further comprising:
an extension indentation, extended from the center of the space of the winding element, wherein the second shaft hole is on the end of the extension indentation; and
an extension section, on the lid and engaged into the extension indentation of the winding element, wherein the first shaft hole is on the end of the extension section.

3. The single-cord control device for roller blind according to claim 2, further comprising:
an engagement part, at the extension section of the lid for fixing the interior end of the spiral spring; and
a flap, set inside the space of the winding element for fixing the exterior end of the spiral spring.

4. The single-cord control device for roller blind according to claim 1, wherein the rear end of the second shaft is assembled with a curtain torque rod.
